(19) United States
(12) Patent Application Publication
(10) Pub. No.: US 2024/0196380 A1
(43) Pub. Date: Jun. 13, 2024

(54) Multi-Station Block Acknowledgment Frame with Padding

(71) Applicant: Ofinno, LLC, Reston, VA (US)

(72) Inventors: Kazi Mohammed Saidul Huq, Herndon, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/530,285

(22) Filed: Dec. 6, 2023

Related U.S. Application Data
(60) Provisional application No. 63/431,758, filed on Dec. 12, 2022.

(51) Int. Cl. H04W 72/0446; H04L 1/00; H04L 5/00; H04W 72/1268

(52) U.S. Cl. CPC H04W 72/0446; H04L 1/0008; H04L 5/0053; H04W 72/1268

(57) ABSTRACT

Systems and methods for multi-station (multi-STA) acknowledgement are disclosed. An access point (AP) transmits a trigger frame soliciting one or more trigger-based (TB) physical protocol data unit (PPDU) from a first station (STA) and a second STA and comprising a first and a second uplink resource allocation for the first STA and a third and a fourth uplink resource allocation for the second STA. The AP receives, in response to the trigger frame, a first TB PPDU from the first STA, via the first uplink resource allocation, and a second TB PPDU from the second STA, via the third uplink resource allocation, and transmits a multi-STA block acknowledgement (BA) frame comprising padding bits to the first and second STA.

### CROSS-REFERENCE TO RELATED APPLICATIONS

This application claims the benefit of U.S. Provisional Application No. 63/431,758, filed Dec. 12, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QOS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example trigger frame.

FIG. 8 illustrates an example block acknowledgment (BA) frame.

FIG. 9 illustrates an example of uplink transmission in response to a trigger frame.

FIG. 10 illustrates an example of uplink transmission in response to a trigger frame according to an embodiment.

FIG. 11 illustrates an example trigger frame according to an embodiment.

FIG. 12 illustrates an example trigger frame according to an embodiment.

FIG. 13 illustrates an example of uplink transmission in response to a trigger frame according to an embodiment.

FIG. 14 illustrates an example of uplink transmission in response to a trigger frame according to an embodiment.

FIG. 15 illustrates an example multi-station (STA) BA frame with padding according to an embodiment.

FIG. 16 illustrates an example multi-STA BA frame with padding according to an embodiment.

FIG. 17 illustrates an example multi-STA BA frame with padding according to an embodiment.

FIG. 18 illustrates a BA type subfield encoding of a multi-STA BA frame with padding according to an embodiment.

FIG. 19 illustrates an example multi-STA BA frame with padding according to an embodiment.

FIG. 20 illustrates an example process according to an embodiment.

FIG. 21 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

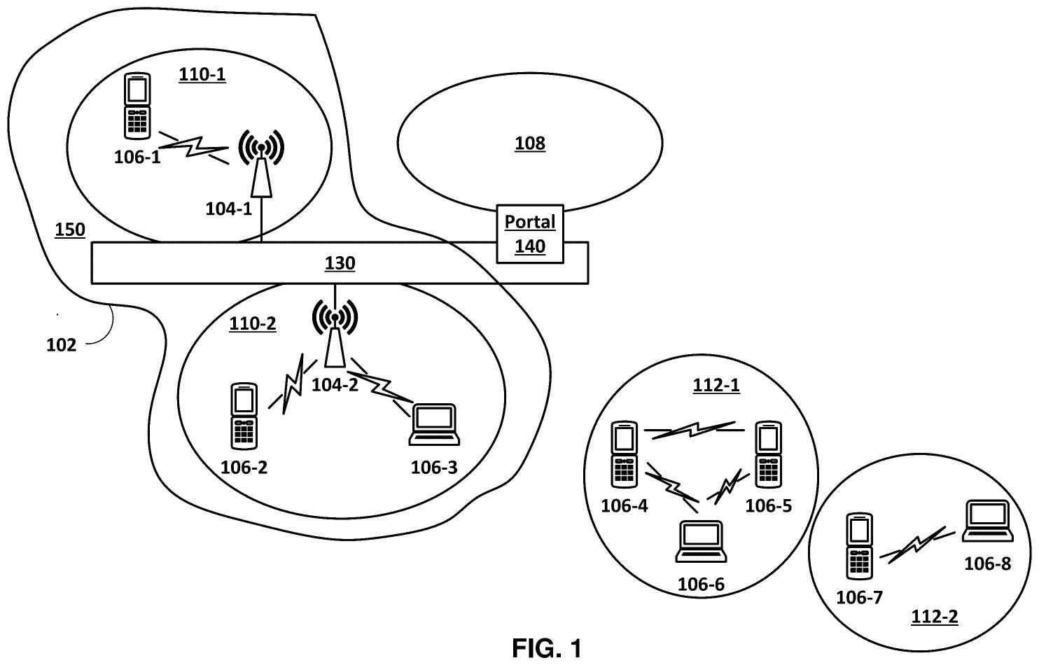

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHZ bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHz, or 320 MHz by bonding together multiple 20 MHz channels.

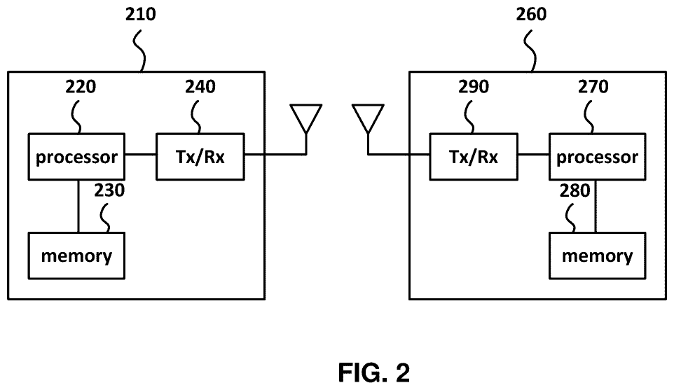

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

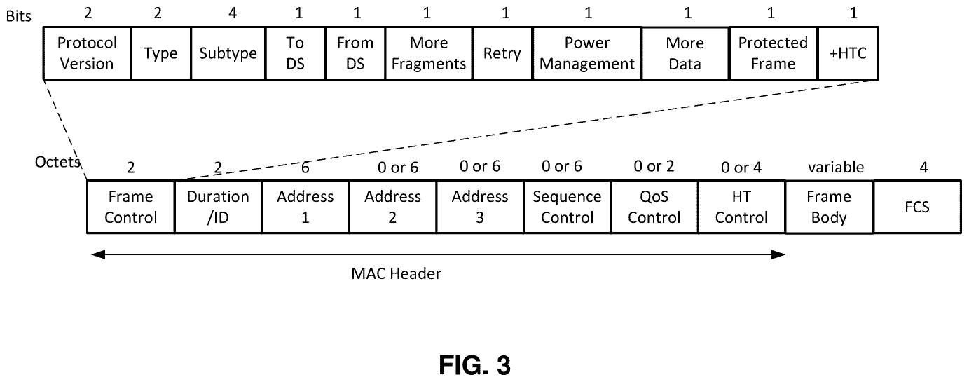

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

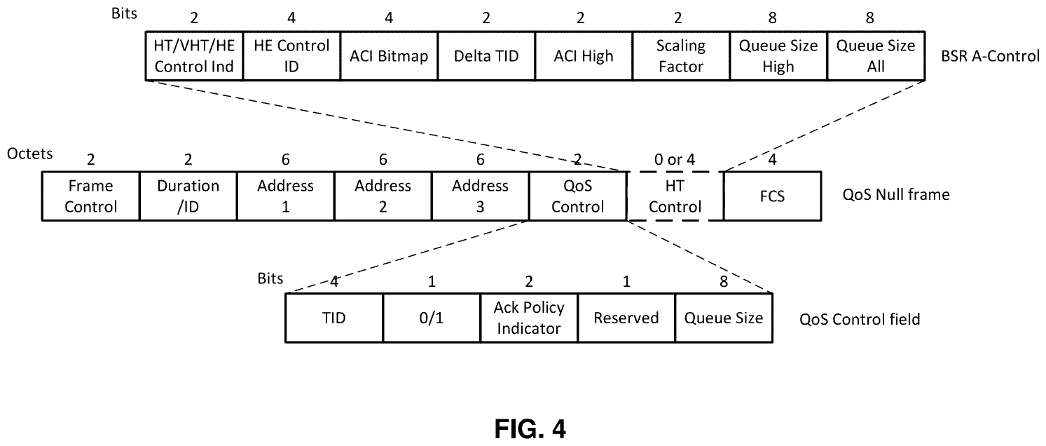

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for uplink (UL) multi-user (MU) operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all Acs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

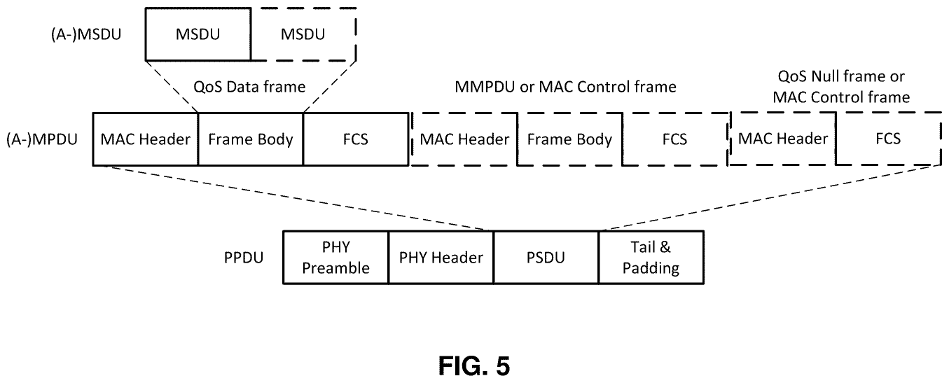

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

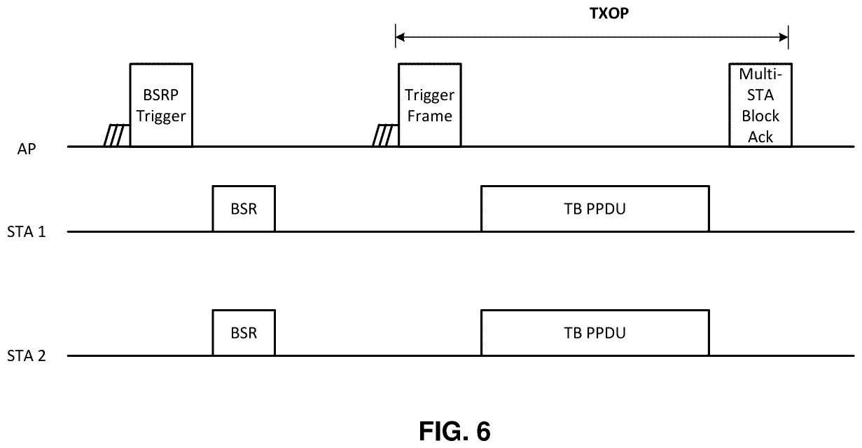

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g. TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID 2. The AP may acknowledge the transmitted TB PPDUs from STA 1 and STA 2 by sending a multi-STA block ack frame.

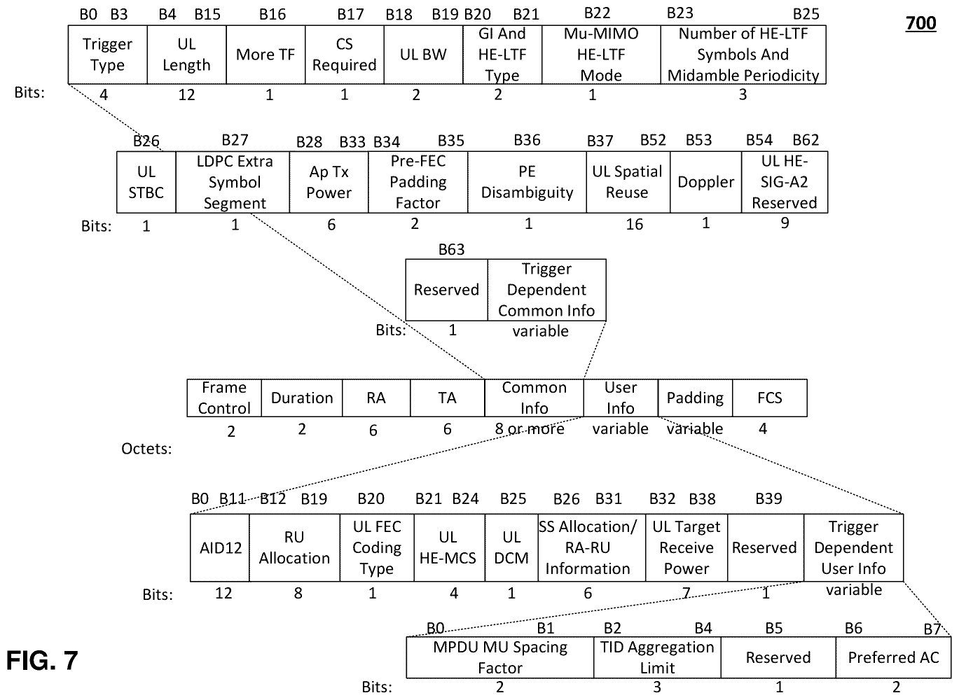

FIG. 7 illustrates an example trigger frame 700. Trigger frame 700 may correspond to a basic trigger frame as defined in the existing IEEE 802.11ax standard amendment. Trigger frame 700 may be used by an AP to allocate resources for and solicit one or more TB PPDU transmissions from one or more STAs. Trigger frame 700 may also carry other information required by a responding STA to transmit a TB PPDU to the AP.

As shown in FIG. 7, trigger frame 700 includes a Frame Control field, a Duration field, a receiver address (RA) field, a transmitter address (TA) field, a Common Info field, a User Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 700 if trigger frame 700 is addressed to STAs that belong to a single BSS. The TA field is the transmitted BSSID if the trigger frame 700 is addressed to STAs from at least two different BSSs of the multiple BSSID set.

The Common Info field specifies a trigger frame type of trigger frame 700, a transmit power of trigger frame 700 in dBm, and several key parameters of a TB PPDU that is transmitted by a STA in response to trigger frame 700. The trigger frame type of a trigger frame used by an AP to receive QoS data using UL MU operation is referred to as a basic trigger frame.

The User Info field contains a User Info field per STA addressed in trigger frame 700. The per STA User Info field includes, among others, an AID subfield, an RU Allocation subfield, a Spatial Stream (SS) Allocation subfield, an MCS subfield to be used by a STA in a TB PPDU transmitted in response to trigger frame 700, and a Trigger Dependent User Info subfield. The Trigger Dependent User Info subfield i can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 700 to extend the frame length to give recipient STAs enough time to prepare a response for transmission one SIFS after the frame is received. The Padding field, if present, is at least two octets in length and is set to all 1 s.

The FCS field is used by a STA to validate a received frame and to interpret certain fields from the MAC headers of a frame.

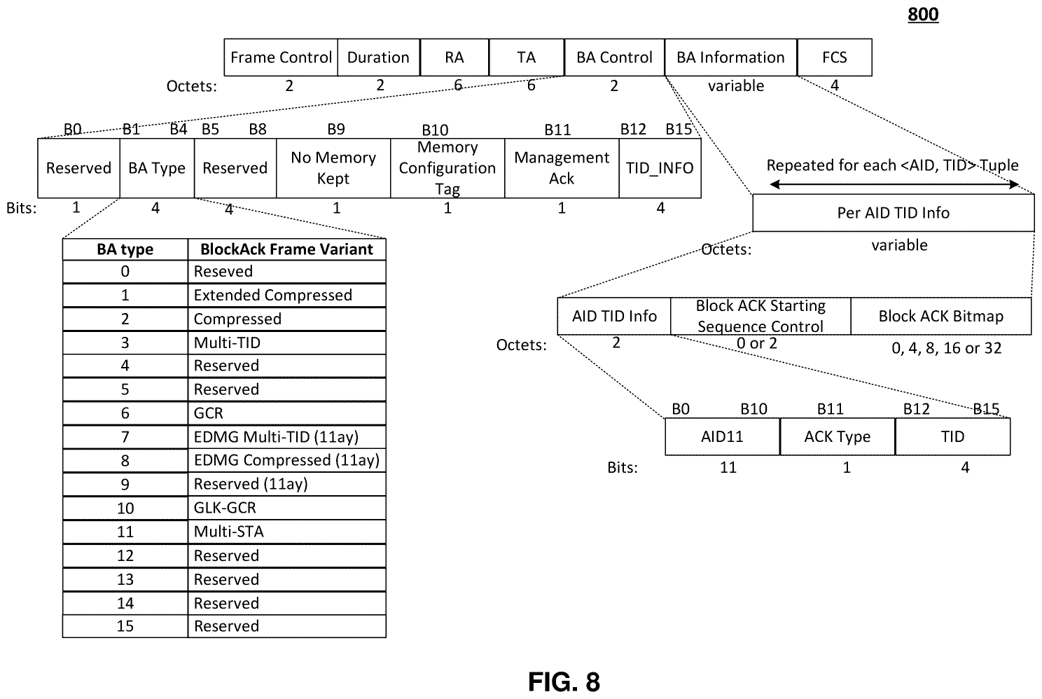

FIG. 8 illustrates an example BlockAck (BA) frame 800. BA frame 800 may correspond to a multi-STA BlockAck (multi-STA BA) frame as defined in the existing IEEE 802.11ax/be standard amendment. BA frame 800 may be used by an AP to acknowledge one or more successfully received TB PPDU transmissions from one or more STAs. BA frame 800 may also carry other information required by a responding STA to transmit a TB PPDU to the AP. According to IEEE 802.11 ax/be standard amendments, a multi-STA BA frame is supported if either UL MU or multi-TID A-MPDU operation is supported. Further, the multi-STA BA acknowledges MPDUs carried in a TB PPDU or multi-STA multi-TID, multi-STA single-TID, or single-STA multi-TID A-MPDUs.

As shown in FIG. 8, BA frame 800 includes a Frame Control field, a Duration field, a RA field, a TA field, a block acknowledgment (BA) control field, a BA information field, and an FCS field.

The Frame Control and Duration fields may be similar to corresponding fields described above with respect to trigger frame 700 shown in FIG. 7.

The RA field may include the address of the STA intended to receive BA frame 800. The TA field may include the address of the STA transmitting BA frame 800 if BA frame 800 is addressed to STAs that belong to a single BSS.

The BA Control field includes the following subfields: reserved, BA type, reserved, no memory kept, memory configuration tag, management ACK, and TID_INFO. As shown FIG. 8, the BA type subfield indicates BA frame variants. The BA type subfield comprises 4 bits. For example, BA type 11 (1011 in binary) represents a multi-STA BA variant. The no memory kept, memory configuration tag, and the management ACK subfields are reserved for 802.11ay standard amendments. The TID_INFO subfield may be reserved.

The BA Information field is sent as an acknowledgment to QoS Data frames that solicit a Multi-STA BA frame response. The BA information field may include a Per AID TID Info subfield that comprises a variable number of octets. The Per AID TID Info subfield may include the following subfields: AID TID Info (2 octets), Block Ack Starting Sequence Control (0 or 2 octets), and Block Ack Bitmap (0, 4, 9, 19, 32, 64, or 128 octets).

The AID TID Info subfield contains three subfields: AID11, ACK Type, and TID. The AID 11 subfield carries the 11 LSBs of the AID of the STA for which the Per AID TID Info subfield is intended. The ACK type and the TID subfields provide different acknowledgment contexts of the multi-STA BA frame. The Block Ack Starting Sequence Control subfield of the Per AID TID Info contains the sequence number of the first MSDU or A-MSDU for which the multi-STA BA frame is sent. The Block Ack Bitmap subfield of the BA Information field is used to indicate the received status of A-MSDUs for the STA.

The FCS field is used by a STA to validate a received frame and to interpret certain fields from the MAC headers of a frame.

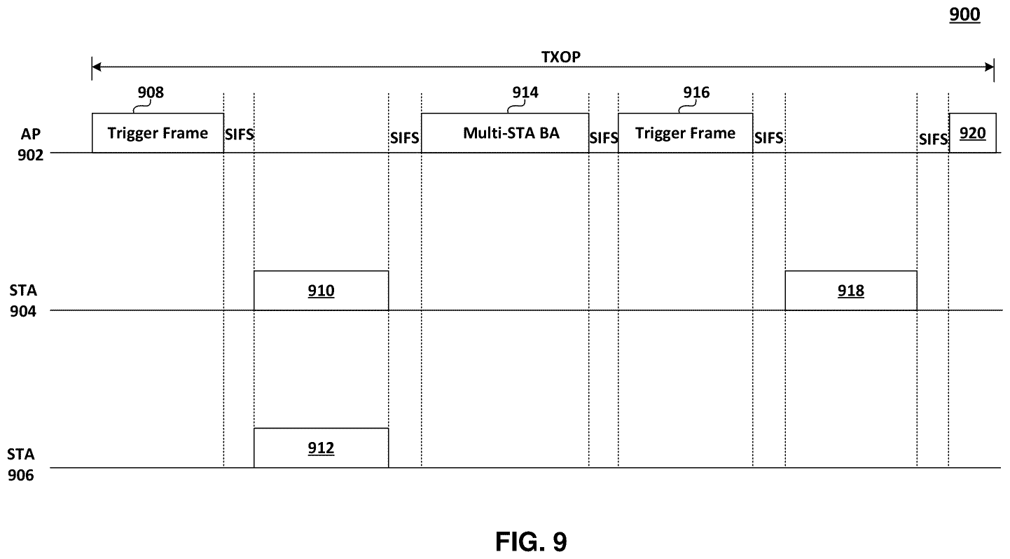

FIG. 9 illustrates an example 900 of uplink transmission in response to a trigger frame. As shown in FIG. 9, example 900 includes an AP 902, a STA 904, and a STA 906. In an example, STAs 904 and 906 may be associated with AP 902.

In an example, AP 902 may obtain a TXOP and transmit a basic trigger frame 908 to STA 904 and STA 906. Trigger frame 908 may identify STAs 904 and 906 and may allocate a first resource (e.g., resource unit (RU) and/or spatial stream) to STA 904 and a second resource to STA 906.

In response to trigger frame 908, STA 904 may transmit, via the first resource, a TB PPDU 910 to AP 902, and STA 906 may transmit, via the second resource, a TB PPDU 912 to AP 902. STAs 904 and 906 may transmit TB PPDUs 910 and 912 one Short Inter-Frame Spacing (SIFS) after reception of trigger frame 908.

Assuming all MPDUs contained in TB PPDUs 910 and 912 are successfully received, AP 902 may acknowledge TB PPDUs 910 and 912 by transmitting a multi-STA BA frame 914 to STAs 904 and 906. AP 902 may transmit multi-STA BA frame 914 one SIFS after reception of TB PPDUs 910 and 912. In another example, AP 902 may acknowledge TB PPDUs 910 and 912 by transmitting a separate BA frame to each of STAs 904 and 906.

According to the existing IEEE 802.11ax/be standard amendments, to allocate to a STA, using a trigger frame, multiple resources for multiple uplink transmissions in time (e.g., an initial transmission and one or more subsequent transmissions or re-transmissions), an AP must transmit multiple trigger frames to the STA each allocating a respective resource for a respective uplink transmission. For example, referring to FIG. 9, to allocate a further resource to STA 904 (after transmission of TB PPDU 910, via the first resource, by STA 904), AP 902 would need to transmit a further trigger frame 916 identifying STA 904 and assigning the further resource to STA 904. STA 904 may then transmit a further TB PPDU 918, via the assigned further resource, to AP 902. STA 904 may transmit TB PPDU 818 one SIFS after receiving trigger frame 916. AP 902 may acknowledge TB PPDU 918 by transmitting a BA frame 920 to STA 904.

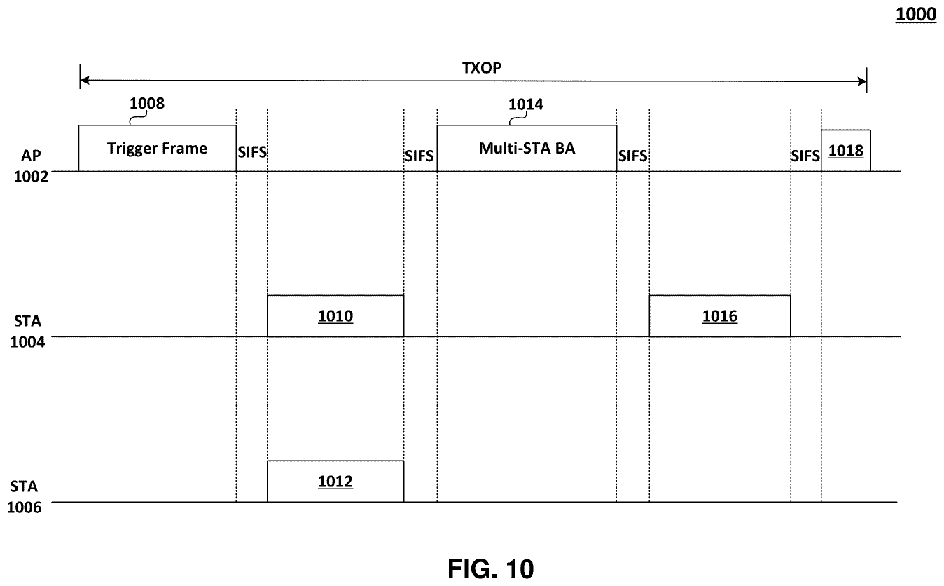

FIG. 10 illustrates an example 1000 of uplink transmission in response to a trigger frame according to an embodiment. Example 1000 is provided for the purpose of illustration only and is not limiting of embodiments of the present disclosure. As shown in FIG. 10, example 1000 includes an AP 1002, a STA 1004, and a STA 1006. In an example, STAs 1004 and 1006 may be associated with AP 1002.

In an example, AP 902 may obtain a TXOP and transmit a trigger frame 908 to STAs 904 and 906. Trigger frame 908 may be a frame that solicits one or more trigger-based (TB) physical layer (PHY) protocol data unit (PPDU) from one or more of STAs 904 and 906.

In an embodiment, trigger frame 908 includes a first indication associated with a first uplink resource allocation for the STA 904; and a second indication associated with a second uplink resource allocation for STA 904. In an embodiment, an uplink resource allocation may include a frequency resource and/or a spatial resource. The uplink resource allocation is associated with a time resource associated with a transmission interval.

A frequency resource may include a resource unit (RU), which includes one or more tones or frequency subcarriers.

A spatial resource may include one or more spatial dimensions. A spatial dimension may be created by the use of multiple antennas at both ends of a communication link. A spatial stream may comprise a bit stream or modulated symbols transmitted over a respective spatial dimension.

In an embodiment, the first uplink resource allocation and the second resource uplink allocation contained in trigger frame 1008 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a time division duplex (TDD) slot as defined in the IEEE 802.11 standard. In another embodiment, the first/second transmission interval may correspond in duration to a portion of a TDD slot as defined in the IEEE 802.11 standard.

In response to trigger frame 1008, STA 1004 may transmit a frame 1010, via the first uplink resource allocation, to AP 1002. Frame 1010 may include a TB PPDU. In an embodiment, the first time resource associated with the first uplink resource allocation starts at a first time spacing from an end of transmission of trigger frame 1008. In an embodiment, as shown in FIG. 10, the first time spacing equals a short interframe spacing (SIFS) duration, and frame 1010 is transmitted one SIFS after transmission of trigger frame 1008.

In an embodiment, trigger frame 1008 may further include a third indication associated with a third uplink resource allocation for STA 1006. In an embodiment, as shown in FIG. 10, the third uplink resource allocation may be associated with a same time resource as the first uplink resource allocation allocated to STA 1004. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1004. The third uplink resource allocation may be associated with a different frequency resource and/or a different spatial resource than the second uplink resource allocation.

In response to trigger frame 1008, STA 1006 may transmit a frame 1012, via the third uplink resource allocation, to AP 1002. Frame 1012 may include a TB PPDU. In an embodiment, the time resource associated with the third resource allocation starts at a third time spacing from an end of transmission of trigger frame 1008. In an embodiment, as shown in FIG. 10, the third time spacing equals a short interframe spacing (SIFS) duration, and frame 1012 is transmitted one SIFS after transmission of trigger frame 1008.

In an embodiment, AP 1002 may transmit a frame 1014 after receiving frames 1010 and 1012 from STAs 1004 and 1006 respectively. Frame 1014 may include a multi-STA BA frame. In an embodiment, frame 1014 may be transmitted one SIFS after reception of frames 1010 and 1012 by AP 1002.

In an embodiment, upon receiving frame 1014 from AP 1002, STA 1004 may transmit a frame 1016, via the second uplink resource allocation, to AP 1002. Frame 1016 may include a TB PPDU. In an embodiment, the second time resource associated with the second uplink resource allocation starts at a second time spacing from an end of transmission of frame 1014 transmitted by AP 1002 in response to frames 1010 and 1012. In an embodiment, as shown in FIG. 10, the second time spacing equals a SIFS duration, and frame 1016 is transmitted one SIFS after reception of frame 1014 by STA 1004.

In an embodiment, in response to frame 1016, AP 1002 may transmit a frame 1018 to STA 1004. Frame 1018 may be a BA frame acknowledging frame 1016.

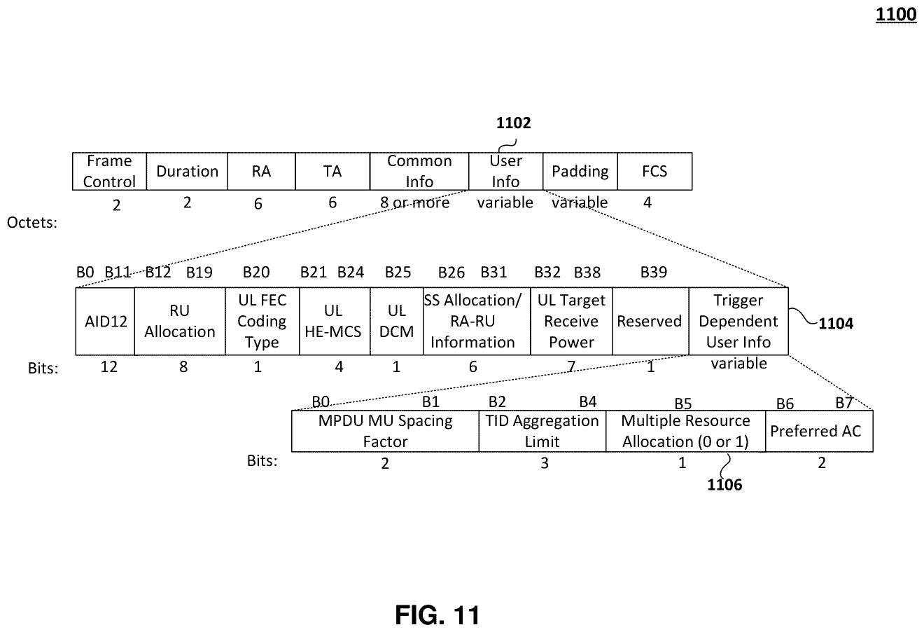

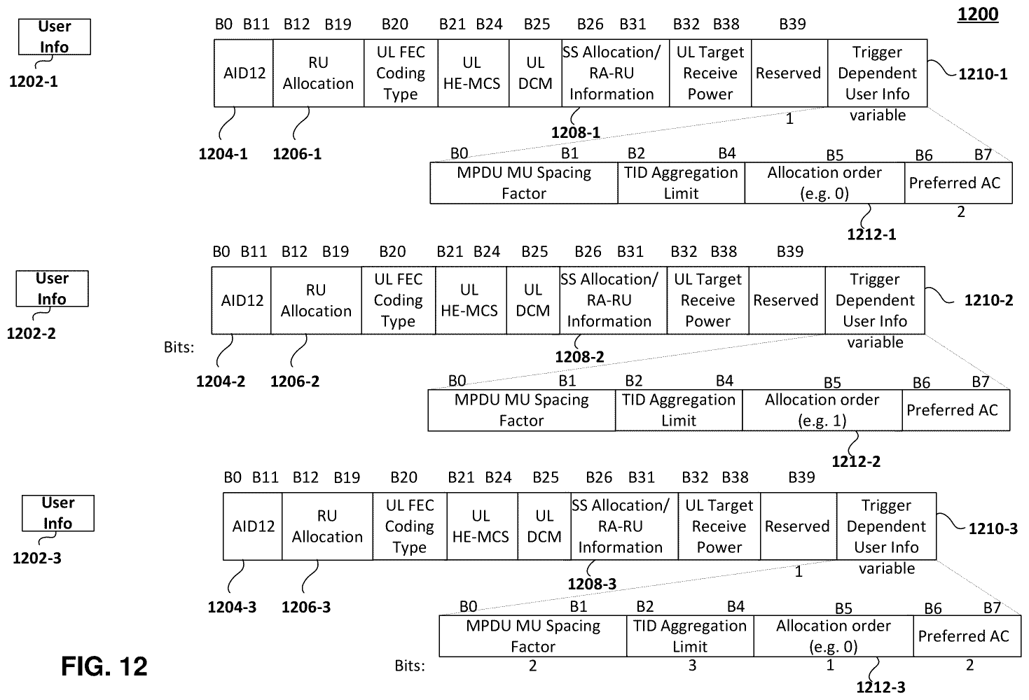

As described above, a trigger frame according to embodiments may include a first indication associated with a first uplink resource allocation for a STA; and a second indication associated with a second uplink resource allocation for the STA. FIGS. 11 and 12 described below provide example trigger frame formats which may be used to implement embodiments of the present disclosure.

FIG. 11 illustrates an example 1100 of a trigger frame format according to an embodiment. Example trigger frame 1100 is provided for the purpose of illustration only and is not limiting of embodiments. Example trigger frame 1100 may be a modified version of a basic trigger frame as defined in the existing IEEE 802.11ax standard amendment. Specifically, trigger frame 1100 may include a modified User Info field 1102, a modified Trigger Dependent User Info subfield 1104 (within the modified user info field 1102), and a new Multiple Resource Allocation subfield 1106 (within the modified Trigger Dependent User Info subfield 1104). Multiple Resource Allocation subfield 1106 replaces a Reserved Bit of the Trigger Dependent User Info subfield of the (User Info field of) existing basic trigger frame.

In an embodiment, an RU Allocation subfield and/or an SS (Spatial Stream) Allocation subfield of User Info field 1102 may carry the first indication associated with the first uplink resource allocation. For example, when the first uplink resource allocation includes a frequency resource, the RU Allocation subfield may include a value that maps to an RU index associated with an RU being allocated to the STA. In another example, when the first uplink resource allocation includes a spatial resource, the SS Allocation subfield may include a first value corresponding to a starting spatial stream and a second value corresponding to a number of spatial streams allocated to the STA (the first value and the second value are hereinafter referred to as a spatial stream allocation).

In an embodiment, the Multiple Resource Allocation subfield 1106 may carry the second indication associated with the second uplink resource allocation. Specifically, in an embodiment, the Multiple Resource Allocation subfield 1106 comprises an indication of presence or absence of the second uplink resource allocation in trigger frame 1100.

In an embodiment, the Multiple Resource Allocation subfield 1106 may take a value of 0 to indicate absence of the second uplink resource allocation in trigger frame 1100. As such, the STA is allocated a single resource allocation in trigger frame 1100.

In an embodiment, the Multiple Resource Allocation subfield 1106 may take a value of 1 to indicate presence of, and to implicitly signal, the second uplink resource allocation in trigger frame 1100. In an embodiment, when the Multiple Resource Allocation subfield 1106 is equal to 1, the STA assumes that the frequency resource and/or the spatial resource associated with the second uplink resource allocation are equal to the frequency resource and/or the spatial resource associated with the first uplink resource allocation. In another embodiment, when the Multiple Resource Allocation subfield 1106 is equal to 1, the STA determines the frequency resource and/or the spatial resource associated with the second uplink resource allocation based on the frequency resource and/or the spatial resource associated with the first uplink resource allocation. For example, the STA may use a predetermined rule to determine the frequency resource and/or the spatial resource associated with the second uplink resource allocation based on the frequency resource and/or the spatial resource associated with the first uplink resource allocation (e.g., if the frequency resource associated with the first uplink resource allocation is equal to RUᵢ, then the frequency resource associated with the first uplink resource allocation may be equal to f(RUᵢ), where f( ) is a function representing the predetermined rule).

As shown in FIG. 11, User Info field 1102 is a variable field such that it may include multiple User Info fields 1102 for multiple STAs. According to embodiments, trigger frame 1100 may thus be used to signal resource allocations for multiple STAs at the same time. The resource allocation for a given STA of the multiple STAs may include a single resource allocation or multiple resource allocations as described above.

FIG. 12 illustrates an example of a trigger frame 1200 according to an embodiment. Example trigger frame 1200 is provided for the purpose of illustration only and is not limiting of embodiments. Example trigger frame 1200 may be a modified version of a basic trigger frame as defined in the existing IEEE 802.11ax standard amendment.

As shown in FIG. 12, trigger frame 1200 may include multiple User Info fields 1202-1, 1202-2, and 1202-3. In an embodiment, User Info fields 1202-1 and 1202-2 may be associated with a same first STA being allocated by the AP, while User Info field 1202-3 may be associated with a second STA being allocated by the AP in trigger frame 1200.

A User Info field 1202 of trigger frame 1200 may be a modified version of the User Info field of the basic trigger frame. Specifically, a User Info field 1202 may include, among others, an AID12 subfield 1204, an RU Allocation subfield 1206, an SS Allocation subfield 1208, a modified Trigger Dependent User Info subfield 1210.

The AID12 subfield 1204 includes an association identifier (AID) of the STA being allocated by the User Info field 1202. For example, in example trigger frame 1200, AID12 subfields 1204-1 and 1204-2 may include the AID of the first STA being allocated by the AP, and AID subfield 1204-3 may include the AID of the second STA being allocated by the AP.

The RU Allocation subfield 1206 and/or the SS Allocation subfield 1208 may carry an indication associated with an uplink resource allocation for the STA being allocated by the User Info field 1202. For example, when the uplink resource allocation includes a frequency resource, the RU Allocation subfield 1206 may include a value that maps to an RU index associated with an RU being allocated to the STA. In another example, when the uplink resource allocation includes a spatial resource, the SS Allocation subfield 1208 may include a first value corresponding to a starting spatial stream and a second value corresponding to a number of spatial streams allocated to the STA.

In an embodiment, when trigger frame 1200 includes multiple User Info fields 1202 for a STA, the first occurring User Info field (e.g., User Info field 1202-1) among the multiple User Info fields for the STA may include a first indication associated with a first uplink resource allocation for the STA. A subsequent User Info field (e.g., User Info field 1202-2) among the multiple User Info fields for the STA may include a second indication associated with a second uplink resource allocation for the STA.

In another embodiment, when trigger frame 1200 includes multiple User Info fields 1202 for a STA, an Allocation Order subfield 1212 of the Trigger Dependent User Info subfield 1210 may be used to associate the indication of uplink resource allocation contained in the User Info field with a respective time resource. For example, in example trigger frame 1200, Allocation Order subfield 1212-1 of Trigger Dependent User Info subfield 1210-1 may have a value of 0, thereby associating the first indication associated with the first uplink resource allocation contained in User Info field 1202-1 with a first time resource. In an embodiment, the first time resource may start at a first time spacing from an end of transmission of trigger frame 1200. Allocation Order subfield 1212-2 of Trigger Dependent User Info subfield 1210-2 may have a value of 1, thereby associating the second indication of the second uplink resource allocation contained in User Info field 1202-2 with a second time resource. The second time resource associated may start at a second time spacing from an end of transmission of a frame (e.g., BA or multi-STA BA) that is transmitted by the AP in response to a frame transmitted by the AP via the first resource allocation (e.g., TB PPDU).

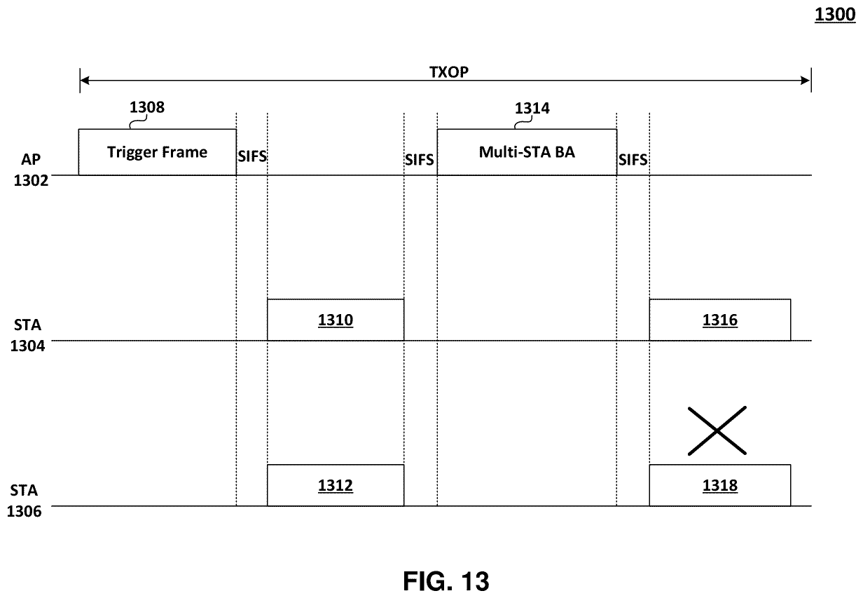

FIG. 13 illustrates an example 1300 of uplink transmission in response to a trigger frame. As shown in FIG. 13, example 1300 includes an AP 1302, a STA 1304, and a STA 1306. In an example, STAs 1304 and 1306 may be associated with AP 1302.

In an example, AP 1302 may obtain a TXOP and transmit a trigger frame 1308 to STAs 1304 and 1306. Trigger frame 1308 may be a frame that solicits one or more trigger-based (TB) physical layer (PHY) protocol data unit (PPDU) from one or more of STAs 1304 and 1306. In particular, trigger frame 1308 may be configured similarly to trigger frame 1008 described above. In an embodiment, trigger frame 1308 includes a first indication associated with a first uplink resource allocation for STA 1304; a second indication associated with a second uplink resource allocation for STA 1304; a third indication associated with a third uplink resource allocation for STA 1306; and a fourth indication associated with a fourth uplink resource allocation for STA 1306.

In an embodiment, an uplink resource allocation may include a frequency resource and/or a spatial resource. The uplink resource allocation is associated with a time resource associated with a transmission interval. In example 1300, the first and third uplink resource allocations may be associated with a first time resource, and the second and the fourth uplink resource allocations may be associated with a second time resource.

In response to trigger frame 1308, STA 1304 may transmit a frame 1310, via the first uplink resource allocation, to AP 1302. Frame 1310 may include a TB PPDU. Similarly, STA 1306 may transmit a frame 1312, via the third uplink resource allocation, to AP 1302. In an embodiment, the first time resource associated with the first and third uplink resource allocations starts at a SIFS from an end of transmission of trigger frame 1308.

On receiving frames 1310 and 1312, AP 1302 may acknowledge frames 1310 and 1312 by transmitting a multi-STA BA frame 1314. AP 1302 may transmit multi-STA BA frame 1314 a SIFS from receiving frames 1310 and 1312.

STAs 1304 and 1306 may be configured to transmit further frames using respectively the third and fourth uplink resource allocations upon receiving multi-STA BA frame 1314. For example, the second time resource associated with the third and fourth uplink resource allocations may be configured to start a SIFS from reception of multi-STA BA frame 1314. In other words, multi-STA BA frame 1314 may act as a trigger frame for further frame transmissions from STAs 1304 and 1306.

In an example, STAs 1304 and 1306 may have different device capabilities (e.g., RF chains, baseband processing, etc.) which may translate into different capabilities to process multi-STA BA frame 1314. For example, STA 1304 may have the capabilities to process multi-STA BA frame 1314 and to prepare a frame 1316 for transmission within a SIFS from receiving multi-STA BA frame 1314. In contrast, having lower processing capabilities, STA 1306 may not be able to process multi-STA BA frame 1314 and be ready to transmit a frame 1318 a SIFS from receiving multi-STA BA frame 1314. As a result, as shown in FIG. 13, STA 1304 may be able to transmit frame 1314 during the second time resource to AP 1302. However, STA 1306 may not be able to transmit frame 1318 during the second time resource. The fourth uplink resource allocation allocated to STA 1306 in trigger frame 1308 may thus be lost.

The above-described problem may particularly occur when multi-STA BA frame 1314 is responsive to a large number of frame transmissions. Further, in some situations, neither of STAs 1304 and 1306 may be able to transmit its further frame in response to multi-STA BA frame 1314. As such, all uplink resource allocations associated with the second time resource may be lost.

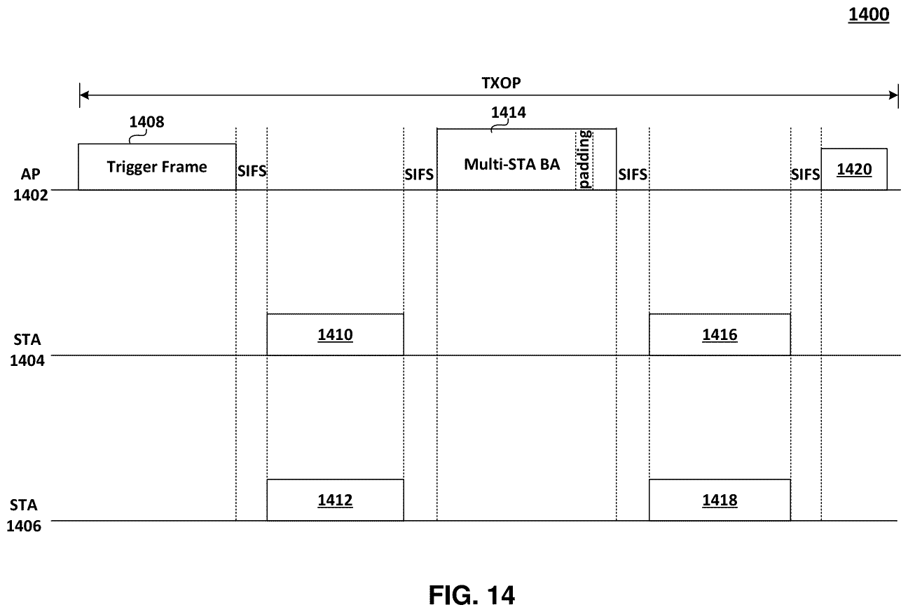

FIG. 14 illustrates an example 1400 of uplink transmission in response to a trigger frame according to an embodiment. Example 1400 is provided for the purpose of illustration only and is not limiting to embodiments of the present disclosure. As shown in FIG. 14, example 1400 includes an AP 1402, a STA 1404, and a STA 1406. In an example, STAs 1404 and 1406 may be associated with AP 1402.

In an example, AP 1402 may obtain a TXOP and transmit a trigger frame 1408 to STAs 1404 and 1406. Trigger frame 1408 may be a frame that solicits one or more TB PPDUs from one or more of STAs 1404 and 1406. In particular, trigger frame 1408 may be configured similarly to trigger frame 1008 described above. In an embodiment, trigger frame 1408 includes a first indication associated with a first uplink resource allocation for STA 1404; a second indication associated with a second uplink resource allocation for STA 1404; a third indication associated with a third uplink resource allocation for STA 1406; and a fourth indication associated with a fourth uplink resource allocation for STA 1406.

In an embodiment, an uplink resource allocation may include a frequency resource and/or a spatial resource. The uplink resource allocation is associated with a time resource associated with a transmission interval. In example 1400, the first and third uplink resource allocations may be associated with a first time resource, and the second and the fourth uplink resource allocations may be associated with a second time resource.

In response to trigger frame 1408, STA 1404 may transmit a frame 1410, via the first uplink resource allocation, to AP 1402. Frame 1410 may include a TB PPDU. Similarly, STA 1406 may transmit a frame 1412, via the third uplink resource allocation, to AP 1402. In an embodiment, the first time resource associated with the first and third uplink resource allocations starts at a SIFS from an end of transmission of trigger frame 1408.

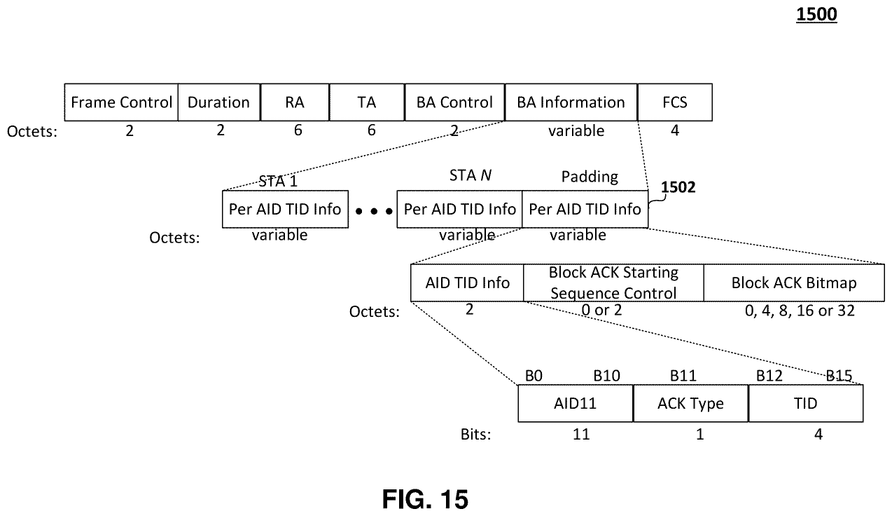

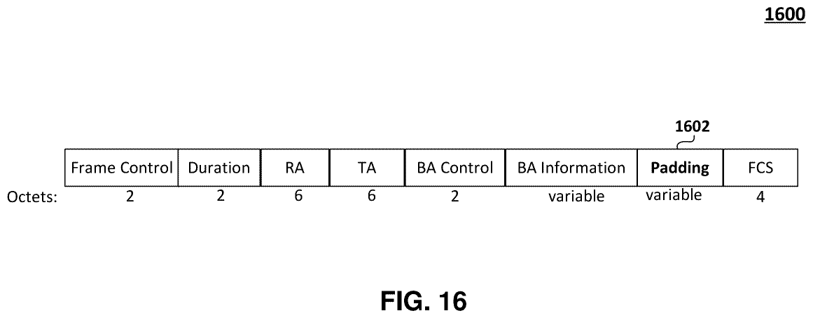

On receiving frames 1410 and 1412, AP 1402 may acknowledge frames 1410 and 1412 by transmitting a multi-STA BA frame 1414. AP 1402 may transmit multi-STA BA frame 1414 a SIFS from receiving frames 1410 and 1412. In an embodiment, multi-STA BA frame 1414 may comprise padding bits. The padding bits may be configured to provide STAs 1404 and 1406 additional time to process multi-STA BA frame 1414 as well as to prepare further frame transmissions triggered by the reception of multi-STA BA frame 1414. In an embodiment, the padding bits may be at least two octets in length and may be all set to 1. In an embodiment, multi-STA BA frame 1414 may have a format as described further below in FIGS. 15 and 16.

On receiving multi-STA BA frame 1414, STAs 1404 and 1406 may decode multi-STA BA frame 1414 to obtain acknowledgment information relating to frames 1410 and 1412 respectively. When STAs 1404 and 1406 reach a field comprising the padding bits, STAs 1404 and 1406 recognize the field as comprising padding bits based on the repeated 1 values of the decoded bits. On detecting the padding bits, STAs 1404 and 1406 may stop decoding multi-STA BA frame 1414 and may proceed to prepare their further frame transmissions (e.g., frames 1416 and 1418 respectively) triggered by multi-STA BA frame 1414. In other words, STAs 1404 and 1406 may begin preparing frames 1416 and 1418 respectively for transmission while multi-STA BA frame 1414 is still being transmitted by AP 1402. As a result, STAs 1404 and 1406 may be able to transmit frames 1416 and 1418 respectively during the second time resource (e.g., a SIFS from end of multi-STA BA frame 1414). The third and fourth uplink resource allocations associated with the second time resource may thus be entirely used by STAs 1404 and 1406.

FIG. 15 illustrates an example multi-STA BA frame 1500 according to an embodiment. Frame 1500 may be an embodiment of multi-STA BA frame 1414 described above. As shown in FIG. 15, frame 1500 may include a frame control field, a duration field, an RA, a TA field, a BA control field, a BA information field, and an FCS field.

In an embodiment, the BA information field may include a plurality of per AID TID info subfields. The number of per AID TID info subfields may correspond to a number of STAs being acknowledged by frame 1500 plus one. The additional per AID TID info subfield 1502 (which may be the last one among the plurality of per AID TID info subfields) may be used to include padding bits.

As shown in FIG. 15, the per AID TID info subfield 1502 may include an AID TID info subfield, a block ACK starting sequence control subfield, and a block ACK bitmap. The AID TID info subfield may include an AID11 subfield, an ACK type subfield, and a TID subfield.

In an embodiment, to convey padding bits, the AID11 subfield may be set to the decimal value 2045, the ACK type subfield may be set to 1, and the TID subfield may be set to the decimal value 15. These decimal values result in a value of 1 for all bits of the AID11, ACK type, and TID subfields.

In another embodiment, to convey the start of padding bits, the AID11 subfield may be set to a special value (e.g., 2043 or 2044). When a receiving STA reads this special value, the STA recognizes the beginning of the padding bits in frame 1500.

FIG. 16 illustrates an example 1600 of a multi-STA BA frame according to an embodiment. Frame 1600 may be an embodiment of multi-STA BA frame 1414 described above. As shown in FIG. 16, frame 1600 may include a frame control field, a duration field, an RA, a TA field, a BA control field, a BA information field, a padding field, and an FCS field. The padding field may have a variable size in octets. In an embodiment, the padding field is at least two octets in length. The bits of the padding field may be all set to 1.

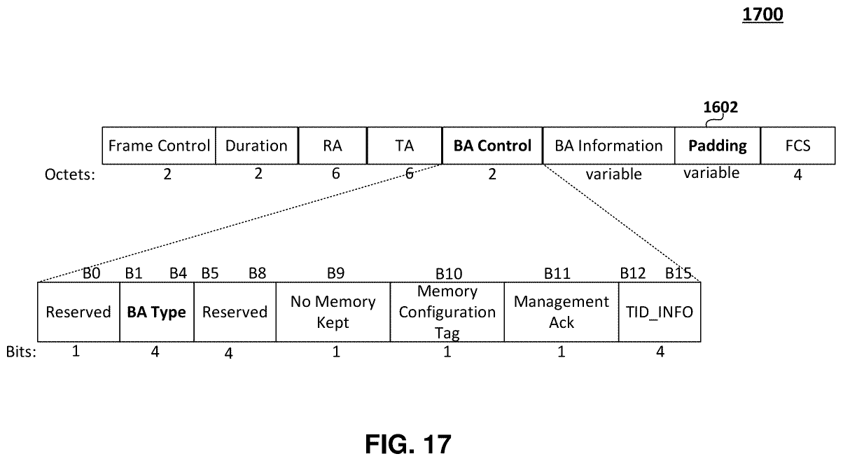

FIG. 17 illustrates an example 1700 of a multi-STA BA frame according to an embodiment. Frame 1700 may be an embodiment of frame 1600 described above. In an embodiment, a BA control field of frame 1700 may include a first reserved bit, a BA type subfield, a second reserved bit, a no memory kept subfield, a memory configuration tag subfield, a management Ack subfield, and a TID_INFO subfield.

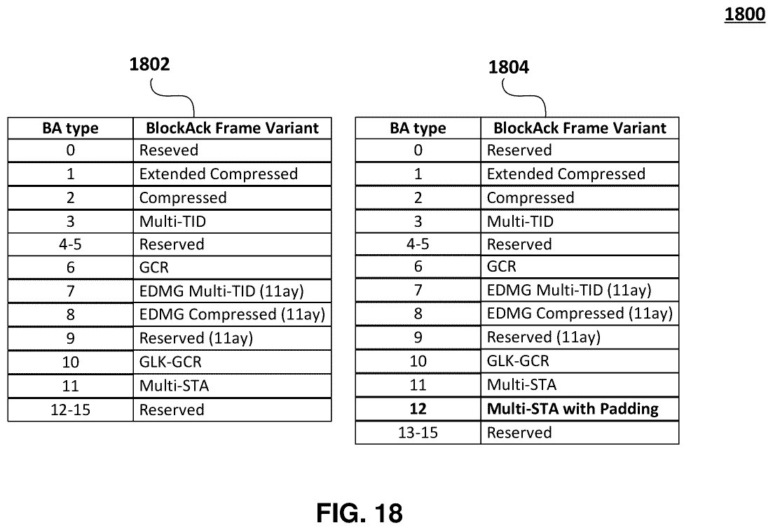

In an embodiment, the BA type subfield of frame 1700 may indicate a BA frame variant corresponding to frame 1700. The BA type subfield may take values according to a BA type subfield encoding as shown in FIG. 18. In an embodiment, an existing BA type encoding 1802 (according to the IEEE 802.11 ax/be standard amendments) may be modified according to a proposed BA type encoding 1804 to provide a BA type value corresponding to a multi-STA BA frame with padding as described herein. In an example, a currently reserved BA type value (e.g., 12-15) may be used for a multi-STA BA frame with padding.

In an embodiment, a STA receiving frame 1700 may read the BA type subfield of the BA control field to identify the BA type of frame 1700. On determining that frame 1700 is a multi-STA BA frame, the STA may adapt its operation as described above to locate the padding field 1602 and to process frame 1700 in accordance with the above-described embodiments.

In a further embodiment, the presence of padding in a multi-STA BA frame may be signaled through the Frame Control field of the MAC frame, with modifications to the Type Value and Subtype Value subfields of the Frame Control field as further described below. For illustration, the table below (Table 1) shows an encoding table for the Type value and the subtype value subfields of a Frame Control Field which may be present in a new control frame serving as a multi-STA BA frame. In the existing 802.11ax/be standard amendment, the value (01) for the Type value subfield (bits B3 B2) and the value (1111) for the Subtype value subfield (bits B7 B6 B5 B4) are reserved bits. In an embodiment, these values (01 and 1111) may be used to indicate a control frame that serves as a multi-STA BA frame with padding.

TABLE 1

| Type | | | |
|---|---|---|---|
| value | Type | Subtype value | |
| B3 B2 | description | B7 B6 B5 B4 | Subtype Description |
| 01 | Control | 0000 | Reserved |
| 01 | Control | 0001 | Reserved |
| 01 | Control | 0010 | Trigger |
| 01 | Control | 0011 | TACK |
| 01 | Control | 0100 | Beamforming Report Poll |
| 01 | Control | 0101 | VHT/HE NDP Announcement |
| 01 | Control | 0110 | Control frame Extension |
| 01 | Control | 0111 | Control Wrapper |
| 01 | Control | 1000 | Block Ack Request |
| | | | (BlockAckReq) |
| 01 | Control | 1001 | Block ACK (BA) |
| 01 | Control | 1010 | Ps-Poll |
| 01 | Control | 1011 | Request-to-Send (RTS) |
| 01 | Control | 1100 | Clear-to-Send (CTS) |
| 01 | Control | 1101 | Ack |
| 01 | Control | 1110 | Contention Free End (CF-End) |
| 01 | Control | 1111 | Multi-STA BA with Padding |

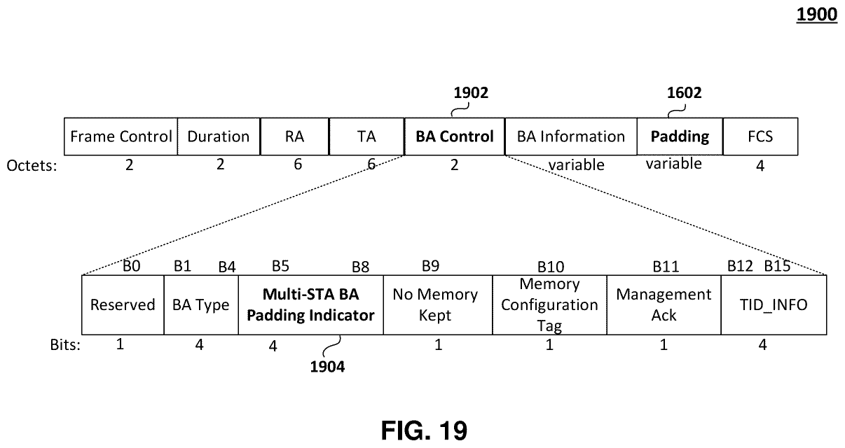

FIG. 19 illustrates an example 1900 of a multi-STA BA frame according to an embodiment. Frame 1900 may be an embodiment of frame 1600 described above. In an embodiment, a BA control field 1902 of frame 1900 may include a first reserved bit, a BA type subfield, a multi-STA BA padding indicator subfield 1904, a no memory kept subfield, a memory configuration tag subfield, a management Ack subfield, and a TID_INFO subfield. The multi-STA BA padding indicator subfield 1904 may occupy the position of a bit that is reserved according to the existing 802.11ax/be standard amendment.

In an embodiment, a STA receiving frame 1900 may read multi-STA BA padding indicator subfield 1904 of BA control field 1902 to determine whether a padding field 1602 is present in frame 1900. On determining that frame 1900 includes padding field 1602 based on the value of multi-STA BA padding indicator subfield 1904, the STA may adapt its operation as described above to locate padding field 1602 and to process frame 1900 in accordance with the above-described embodiments.

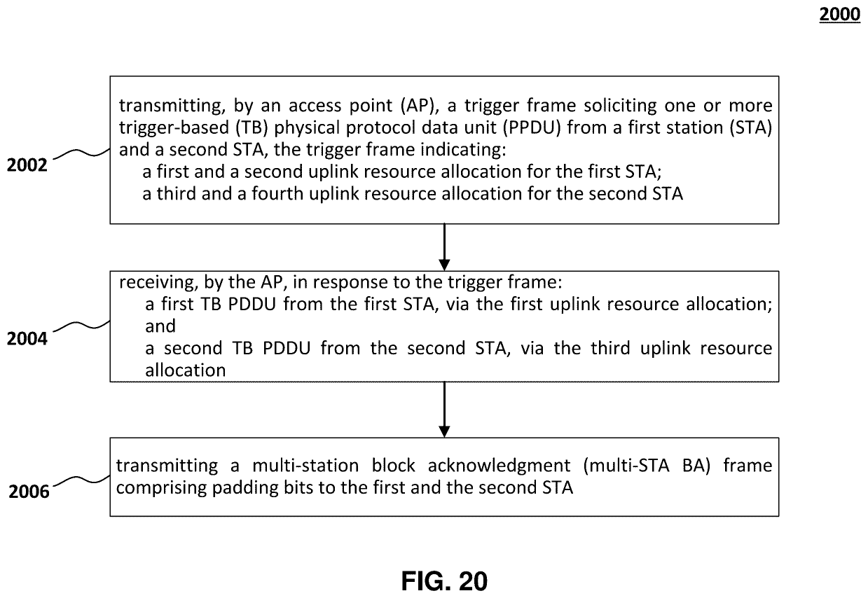

FIG. 20 illustrates an example process 2000 according to an embodiment. Example process 2000 is provided for the purpose of illustration only and is not limiting. Example process 2000 may be performed by an AP, such as AP 1402.

As shown in FIG. 20, process 2000 may begin in step 2002, which includes transmitting a trigger frame soliciting one or more TB PPDU from a first STA, such as STA 1404, and a second STA, such as STA 1404. The trigger frame may indicate: a first and a second uplink resource allocation for the first STA; and a third and a fourth uplink resource allocation for the second STA.

In an embodiment, the first and the third uplink resource allocations are associated with a different time resource than the second and the fourth uplink resource allocations.

In a further embodiment, the first and third uplink resource allocations are associated with a first time resource; and the second and fourth uplink resource allocations are associated with a second time resource.

In step 2004, process 2000 may include receiving, by the AP, a first TB PPDU from the first STA, via the first uplink resource allocation and a second TB PPDU from the second STA, via the third uplink resource allocation, in response to the trigger frame.

In an embodiment, the multi-STA BA frame acknowledges the first TB PPDU and the second TB PPDU.

In step 2006, process 2000 may include transmitting a multi-STA BA frame comprising padding bits to the first and the second STA. In an embodiment, the multi-STA BA frame comprises a padding field comprising one or more padding bits. In a further embodiment, the padding field follows a BA information field of the multi-STA BA frame.

In an embodiment, the multi-STA BA frame comprises a BA control field, the BA control field comprising a BA type subfield indicating that the multi-STA BA frame comprises one or more padding bits. In a further embodiment, the multi-STA BA frame comprises a BA control field, the BA control field comprising a padding subfield indicating that the multi-STA BA frame comprises one or more padding bits.

In an embodiment, the multi-STA BA frame comprises a BA information field comprising one or more padding bits. In a further embodiment, the BA information field comprises one or more Per AID TID info subfields, and the one or more bits are provided in a last Per AID TID info subfield of the one or more Per AID TID subfields.

In an embodiment, process 2000 may further include receiving, by the AP, a third TB PPDU from the first STA, via the second uplink resource allocation; and a fourth TB PPDU from the second STA, via the fourth uplink resource allocation in response to the multi-STA BA frame. The third and the fourth TB PPDUs may be received a short interframe spacing (SIFS) from transmitting the multi-STA BA frame.

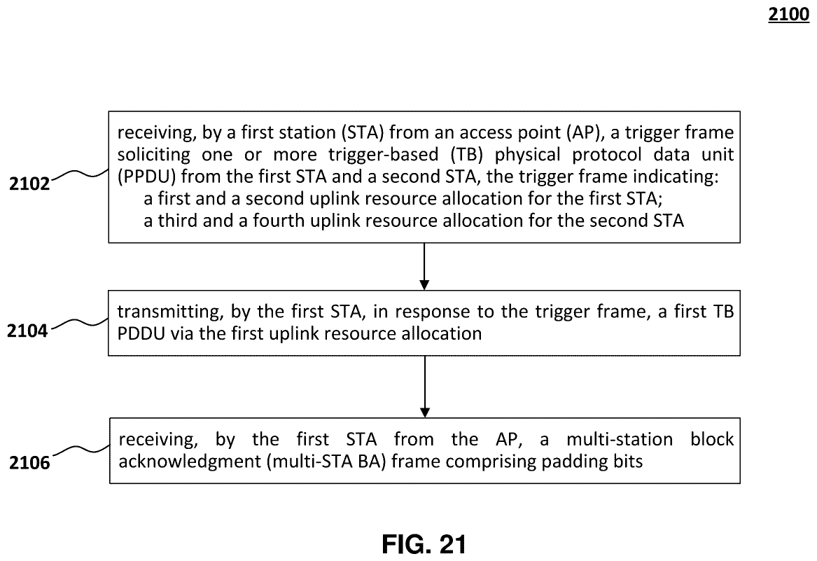

FIG. 21 illustrates an example process 2100 according to an embodiment. Example process 2100 is provided for the purpose of illustration only and is not limiting. Example process 2100 may be performed by a first STA, such as STA 1404 or STA 1406.

As shown in FIG. 21, process 2100 may begin in step 2102, which includes receiving, from an AP, a trigger frame soliciting one or more TB PPDU from the first STA and a second STA. The trigger frame may indicate: a first and a second uplink resource allocation for the first STA; and a third and a fourth uplink resource allocation for the second STA.

In an embodiment, the first and the third uplink resource allocations are associated with a different time resource than the second and the fourth uplink resource allocations.

In an embodiment, the first and third uplink resource allocations are associated with a first time resource. In a further embodiment, the second and fourth uplink resource allocations are associated with a second time resource.

In step 2104, process 2100 may include transmitting a first TB PPDU via the first uplink resource allocation, in response to the trigger frame.

In step 2106, process 2100 may include receiving, from the AP, a multi-STA BA frame comprising padding bits. In an embodiment, the multi-STA BA frame comprises a padding field comprising one or more padding bits. In a further embodiment, the padding field follows a BA information field of the multi-STA BA frame.

In an embodiment, the multi-STA BA frame comprises a BA control field, the BA control field comprising a BA type subfield indicating that the multi-STA BA frame comprises one or more padding bits. In a further embodiment, the multi-STA BA frame comprises a BA control field, the BA control field comprising a padding subfield indicating that the multi-STA BA frame comprises one or more padding bits.

In an embodiment, the multi-STA BA frame comprises a BA information field comprising one or more padding bits. In a further embodiment, the BA information field comprises one or more Per AID TID info subfields, and the one or more bits are provided in a last Per AID TID info subfield of the one or more Per AID TID subfields.

In an embodiment, the multi-STA BA frame acknowledges the first TB PPDU and the second TB PPDU.

In an embodiment, process 2100 may further comprise transmitting, to the AP, in response to the multi-STA BA frame: a second TB PPDU via the second uplink resource allocation. In an embodiment, the second TB PPDU may be transmitted a short interframe spacing (SIFS) from receiving the multi-STA BA frame.

What is claimed is:

1. An access point (AP) comprising:
one or more processors; and
memory storing instructions that, when executed by the one or more processors, cause the AP to:
transmit a trigger frame soliciting one or more trigger-based (TB) physical protocol data unit (PPDU) from a first station (STA) and a second STA, the trigger frame indicating:
a first and a second uplink resource allocation for the first STA; and
a third and a fourth uplink resource allocation for the second STA;
receiving in response to the trigger frame:
a first TB PDDU from the first STA, via the first uplink resource allocation; and
a second TB PDDU from the second STA, via the third uplink resource allocation; and
transmit a multi-station (multi-STA) block acknowledgment (BA) frame comprising padding bits to the first and the second STA.

2. The AP of claim 1, wherein the first and the third uplink resource allocations are associated with a different time resource than the second and the fourth uplink resource allocations.

3. The AP of claim 1, wherein the first and third uplink resource allocations are associated with a first time resource.

4. The AP of claim 3, wherein the second and fourth uplink resource allocations are associated with a second time resource.

5. The AP of claim 1, wherein the multi-STA BA frame acknowledges the first TB PPDU and the second TB PPDU.

6. The AP of claim 2, wherein the instructions, when executed by the one or more processors, further cause the AP to receive, in response to the multi-STA BA frame:
a third TB PDDU from the first STA, via the second uplink resource allocation; and
a fourth TB PDDU from the second STA, via the fourth uplink resource allocation.

7. The AP of claim 1, wherein the multi-STA BA frame comprises a padding field comprising one or more padding bits.

8. The AP of claim 1, wherein the multi-STA BA frame comprises a BA information field comprising one or more padding bits.

9. The AP of claim 8, wherein the BA information field comprises one or more per AID TID info subfields, and wherein the one or more padding bits are provided in a last per AID TID info subfield of the one or more per AID TID info subfields.

10. A station (STA) comprising:
one or more processors; and
memory storing instructions that, when executed by the one or more processors, cause the STA to:
receive from an access point (AP), a trigger frame soliciting one or more trigger-based (TB) physical protocol data unit (PPDU) from the STA and a second STA, the trigger frame indicating:
a first and a second uplink resource allocation for the STA; and
a third and a fourth uplink resource allocation for the second STA,
transmit, in response to the trigger frame, a first TB PDDU via the first uplink resource allocation; and
receive, from the AP, a multi-station (multi-STA) block acknowledgment (BA) frame comprising padding bits.

11. The STA of claim 10, wherein the first and the third uplink resource allocations are associated with a different time resource than the second and the fourth uplink resource allocations.

12. The STA of claim 10, wherein the first and third uplink resource allocations are associated with a first time resource.

13. The STA of claim 12, wherein the second and fourth uplink resource allocations are associated with a second time resource.

14. The STA of claim 10, wherein the multi-STA BA frame acknowledges the first TB PPDU.

15. The STA of claim 10, further comprising transmitting, by the first STA to the AP, in response to the multi-STA BA frame a second TB PDDU via the second uplink resource allocation.

16. The STA of claim 10, wherein the multi-STA BA frame comprises a padding field comprising one or more padding bits.

17. The STA of claim 10, wherein the multi-STA BA frame comprises a BA information field comprising one or more padding bits.

18. The STA of claim 17, wherein the BA information field comprises one or more per AID TID info subfields, and wherein the one or more bits are provided in a last per AID TID info subfield of the one or more per AID TID info subfields.

19. A non-transitory computer-readable medium comprising instructions that, when executed by one or more processors, cause an access point (AP) to:
transmit a trigger frame soliciting one or more trigger-based (TB) physical protocol data unit (PPDU) from a first station (STA) and a second STA, the trigger frame indicating:
a first and a second uplink resource allocation for the first STA; and
a third and a fourth uplink resource allocation for the second STA;
receive in response to the trigger frame:
a first TB PDDU from the first STA, via the first uplink resource allocation; and
a second TB PDDU from the second STA, via the third uplink resource allocation; and
transmit a multi-station (multi-STA) block acknowledgment (BA) frame comprising padding bits to the first and the second STA.

20. The non-transitory computer-readable medium of claim 19, wherein the first and the third uplink resource allocations are associated with a different time resource than the second and the fourth uplink resource allocations.
